(19) United States
(12) Patent Application Publication
(10) Pub. No.: US 2004/0237886 A1
(43) Pub. Date: Dec. 2, 2004

(54) Device and method for despensing a fluid onto a substrate moving relative to the device

(76) Inventors: Hans-Jurgen Meissner, Lueneburg (DE); Gerd Ostermann, Lueneburg (DE); Uwe Lehmann, Bleckede (DE); Juergen Steckelberg, Bleckede (DE)

Correspondence Address: Kevin G. Rooney, Wood Herron & Evans, 2700 Carew Tower, Cincinnati, OH, 45202, US

(21) Appl. No.: 10/475,071

(22) PCT Filed: Mar. 22, 2002
(86) PCT No.: PCT/EP02/03212

(30) Foreign Application Priority Data
Apr. 20, 2001 (DE) 101 19 633.4

(51) Int. Cl. B05C 5/00; B05C 11/00

(52) U.S. Cl. 118/506; 118/300

(57) ABSTRACT

An apparatus for dispensing fluid includes a base member having a feed channel and a slot nozzle having first and second spaced apart members. A slot-shaped outlet channel is in fluid communication with the feed channel and is defined between the first and second spaced apart members. A slot-shaped outlet opening is in fluid communication with the slot-shaped outlet channel and has a width defined between the first and second spaced apart members. A valve is coupled with the base member and selectively interrupts and releases the flow of fluid through the slot-shaped outlet opening. An adjustment device infinitely adjusts the position of the first member relative to the position of the second member to change the width of the slot-shaped outlet opening. A method for dispensing fluid onto a substrate includes directing the fluid through the slot-shaped outlet channel while continuously increasing the pressure of the fluid.

### FIELD OF THE INVENTION

The present invention relates to a device and method for dispensing a fluid onto a substrate moving relative to the device, and more specifically to an intermittent dispensing device and method for dispensing films in a non-contacting manner.

### BACKGROUND OF THE INVENTION

Fluid dispensing devices, sometimes referred to as application heads, are used in various branches of industry to apply various fluid materials such as adhesives, paints or coating materials to sanitary articles, wood products, machine parts, vehicle body parts or the like, continuously or intermittently, in the form of a bead, as a line, as dots or over an area. The devices are connected to a source of fluid, for example, an adhesive reservoir, from which the fluid is directed through the feed channel to a nozzle, with the assistance of a pump if necessary. The fluid stream may be interrupted or released by a valve. When the valve is open the fluid flows through an outlet channel and emerges from an outlet opening of the nozzle under pressure and is then transferred to the substrate, which is moved relative to the outlet opening. In contact type devices the nozzle is in contact with the substrate while the fluid is being applied, while with non-contact devices a separation is maintained between the nozzle arrangement and the substrate.

In industrial applications, various demands are made on the application pattern that develops on the substrate, that is, the three-dimensional or essentially two-dimensional extent of the applied fluid materials. With an essentially two-dimensional application, the nozzle is designed as a slot nozzle with an essentially slot-shaped outlet channel. This type of device produces sharply delimited lateral margins and maximally uniform, two-dimensional distribution of the fluid material with a surface that is as flat as possible. Frequently, it is also desirable or necessary to dispense relatively small quantities of fluid material per unit of area of the substrate surface.

### SUMMARY OF THE INVENTION

In one aspect of the invention, a fluid dispensing device is provided having an outlet channel with a steadily and evenly decreasing flow cross section or taper in the direction of flow of the fluid. A relatively high pressure builds up in the flowing fluid in the direction of flow. The fluid material then flows out of an outlet opening of the outlet channel at a relatively high speed and is then applied to the substrate. In particular, the fluid is to be applied by a method in which the substrate and the nozzle are not in contact with each other.

Particularly when the nozzle is designed as a slot nozzle with an essentially slot-shaped outlet channel, and the flow cross section of the slot-shaped outlet channel according to the invention steadily decreases in the direction of flow of the fluid, i.e., in the direction toward the outlet opening, then according to the invention a sheet or film is dispensed at high speed from the slot-shaped outlet opening of the device and is applied or deposited uniformly on the substrate, which is moving relative to the device.

Because of the tapering flow cross section of the slot-shaped outlet channel, a high pressure is produced in the fluid before the outlet opening, and a high speed is produced, and an extrusion-like production of film or sheet is achieved with uniform film or sheet thicknesses. Due to relatively small separations of about 2 to 10 mm between the outlet opening and the substrate surface, uniform application of a completely closed film is realized using the non-contact method.

The invention provides for continuous variation of the flow cross section of the outlet channel of the nozzle. The flow conditions of the fluid, and in particular the pressure buildup, the flow rate and the width of the outlet opening may be easily varied and adapted to the particular case. For example, by reducing the flow cross section the pressure buildup may be increased and the flow rate increased. The width of the outlet opening may be varied to thereby vary the film thickness. For example, if a film having a small quantity of fluid per unit of area is to be dispensed onto the substrate, the width of the gap is reduced and the mass flow of the fluid is also reduced. According to the invention, specific fluid application quantities of two grams/m² to about 100 grams/m² can be produced on the substrate while realizing a closed film which may have a small film thickness, for example, of 1/10 μm.

In a preferred embodiment of the device according to the invention, the nozzle is designed as a slot nozzle with an essentially slot-shaped outlet channel which is bounded by two members spaced at a distance. An adjusting device is provided for continuous adjustment of one member relative to the other member so that the width of the essentially slot-shaped outlet channel is continuously variable. This embodiment is further refined by having at least part of one of the members bounding the slot-shaped outlet channel be elastically reshapable by the adjusting device in such a way that the width of the outlet channel is variable. A refinement of the adjusting device of simple design provides for the latter to have an adjusting bolt which acts on a projection of the elastically reshapable member. The elastic reshapability of the at least one member bounding the outlet channel may be simply realized by reducing or “thinning” the thickness of the material, for example, by reducing or tapering its cross section, so that when an adjusting force is applied with the adjusting device, an elastic reshaping of the body is produced in such a way that the outlet channel is enlarged or reduced. To produce thin sheets that are to be applied to substrates, the slot-shaped outlet channel is designed as a gap that tapers continuously out to the outlet opening. The width of the outlet opening, in the range between about 0.05 mm and 0.5 mm, is preferably adjustable.

The fact that a pressurized air channel is contained inside the base body results in a compact design, without external hoses or tubes leading to the valve, and the entire construction volume is thereby reduced. The fact that the valve is located in a hole bored in the base body also produces a compact design, and the pressurized air can be fed through the pressurized air channel formed in the base body.

Preferably, the flow cross section of the preferably slot-shaped outlet channel is reduced in such a way that the fluid is under a pressure of about 30 to 100 bar, preferably 40 to 70 bar, in the area of the outlet opening.

According to another aspect of the invention, it is proposed that the fluid should flow through a gap that tapers continuously to a slot-shaped outlet opening and should emerge as a sheet from the slot-shaped outlet opening and then be deposited on the surface of the substrate without contact between the nozzle and the substrate.

It is especially preferable for the fluid to be a constantly sticky hot melt pressure sensitive adhesive, and/or that the fluid be an acrylic-based or rubber-based adhesive or a UV-curing adhesive or some other thermoplastic material.

### BRIEF DESCRIPTION OF THE DRAWINGS

The invention is described below on the basis of an exemplary embodiment of a device and a method for dispensing and applying thermoplastic adhesives on a substrate, with reference to the attached drawings.

FIG. 1 is a partially sectioned view of a device according to the invention for applying fluid.

FIG. 2 is a side view of the device shown in FIG. 1.

FIG. 3 is a sectional view of an upper part of a base body of the device shown in FIG. 1.

FIG. 4 is a sectional view of a lower part of the base body of the device shown in FIG. 1.

FIG. 5 is a top view of the lower part of the base body shown in FIG. 4.

### DETAILED DESCRIPTION

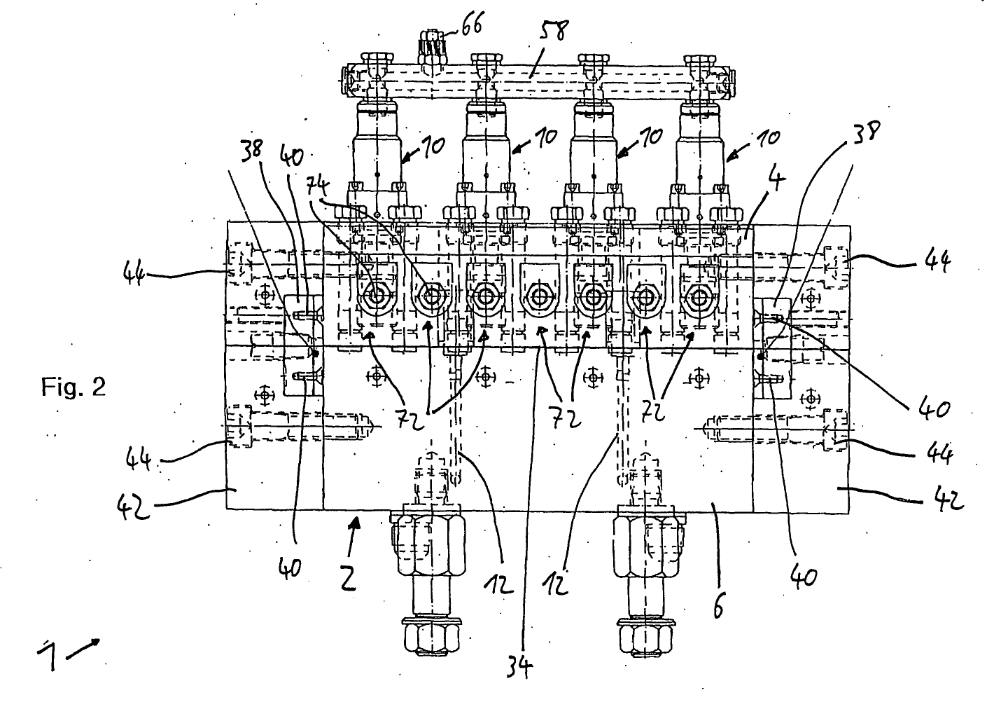

Application device 1 shown in the figures serves in general for applying fluid materials (fluids) onto substrates, and is adapted to the dispensing and application of fluid thermoplastic adhesives in the form of sheets on various substrates such as woven fabric, foil, paper or the like. Application device 1 includes essentially a two-part metal base body 2 that comprises an upper partial body 4 and a lower partial body 6, a nozzle 8 designed as a wide-slot nozzle and as part of base body 2, and a plurality of valves 10 (see also FIG. 2) for selectively interrupting or releasing the flow of the fluid. Valves 10 are pneumatically actuatable with pressurized air, and can frequently also be referred to as control units or control modules.

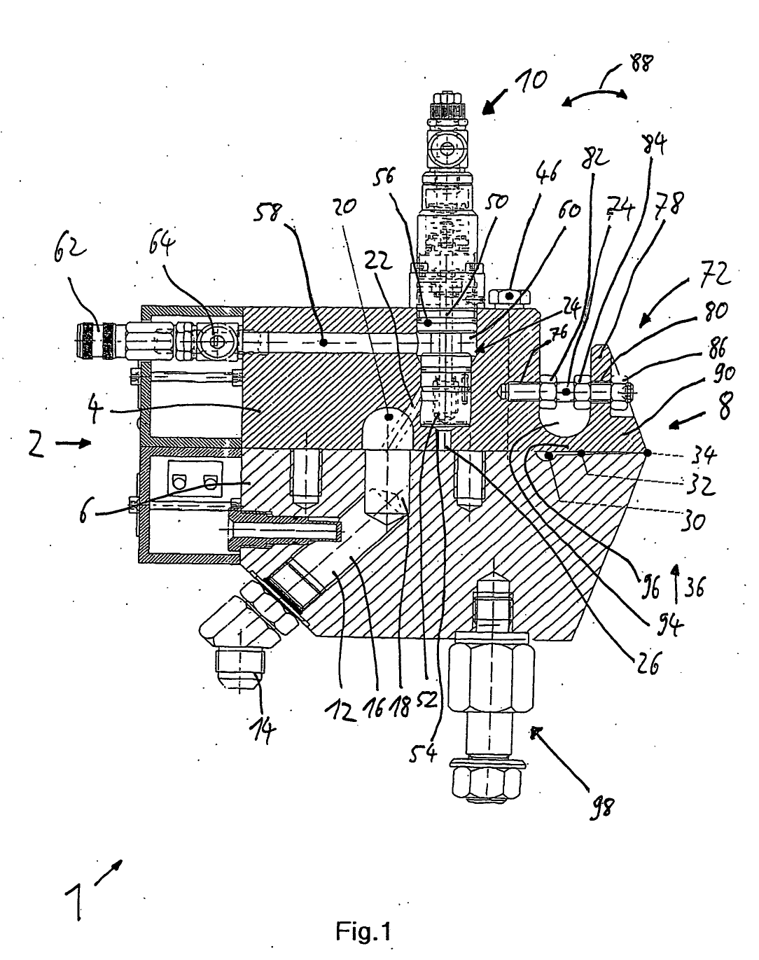

A fluid feed channel 12 (FIG. 1) is formed in lower partial body 6 of base body 2, and is coupled by a fluid fitting 14, in a manner not shown, to a fluid source in the form of a reservoir containing adhesive. The exemplary embodiment is provided with two feed channels 12 (see FIG. 2), which are fed by gear pumps (not shown). Feed channel 12 has a plurality of sub-sections, specifically a first oblique bore 16, a bore 18, a channel 20 formed in body 4, and in each instance an oblique bore 22 communicating with channel 20. Oblique bore 22 issues into a bore 24 formed in partial body 4, into which bore 24 a lower section of each valve arrangement 10 is inserted. Feed channel 12 has additional sections, specifically a bore 26 communicating with bore 24 (FIG. 1), a plurality of U-shaped channels 28 formed in the top of partial body 6 (see FIG. 5), and a distribution channel 30 of essentially semi-circular cross section communicating with the end sections of the sides of the U-shaped channels 28.

An outlet channel 32 of nozzle arrangement 8 is then connected to transverse distribution channel 30. Outlet channel 32 is slot-shaped in the exemplary embodiment, and has an elongated outlet opening 34 (see FIGS. 1 and 2), through which the fluid is dispensed in the form of a sheet or a film and is then applied onto a substrate (not shown). The direction of relative motion between application device 1 and substrate is indicated by arrow 36. Elongated slot-shaped outlet opening 34 extends perpendicular to the drawing plane in FIG. 1.

As FIGS. 4 and 5 show, a total of four U-shaped channels 28 are formed on the top side of lower body 6 and lie essentially in a horizontal plane. Bores 26 communicate with the transverse sides 29 of channels 28, so that fluid is distributed to the two further sides of channels 28 across the width of application device 1. The fluid is then further distributed transversely in the transverse distribution channel 30, which communicates with outlet channel 32 (FIG. 1).

As FIG. 2 shows, transverse distribution channel 30 is laterally bounded and sealed by side hatches 38, to which sealing elements of plastic, preferably PTFE (polytetrafluoroethylene) are affixed by means of screws 40. Base body 2 is closed at the sides by opposing metal plates 42, which are attached using screws 44.

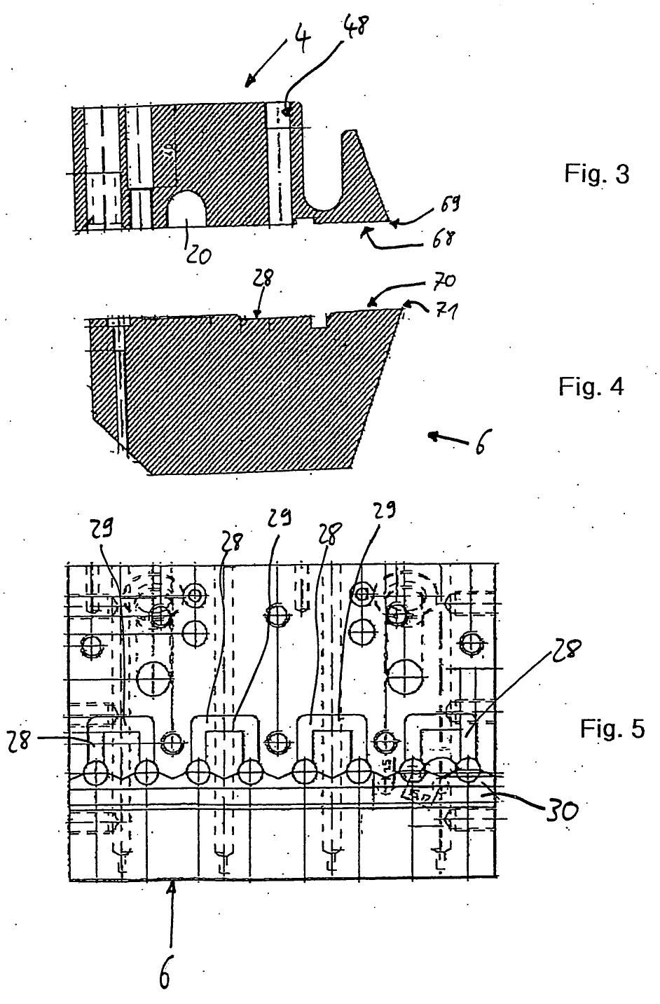

Using a plurality of adjusting screws 46 (see FIG. 1), each assigned to a channel 28 (FIG. 5), which may be screwed into threaded holes 48 (see FIG. 3) formed in upper body 4, it is possible to vary the free flow cross section in channels 28 by screwing the flat-ended screws 46 in to varying depths, so that the flow of fluid through channels 28 may be varied and finely adjusted due to differing flow resistances.

The valve arrangement 10 connected into feed line 12, which is designed in the manner of a control unit, has its lower section inserted into bore 24 of base body 2, and only the upper section protrudes from base body 2. Valve 10 has a valve body 52 that moves together with a valve needle or valve stem 50 and interacts with a valve seat 54 formed on the body 4 of base body 2 in such a way that the flow of fluid into feed channel 12 and thus through the entire application device 2 and in particular through outlet opening 34 may be selectively interrupted or released. To this end, valve body 52 is moved axially up or down together with valve stem 50 by means of a piston 56, which passes through and is sealed in bore 24. In a manner not shown in further detail, above piston 56 is a cylinder chamber constantly filled with pressurized air, which may be filled with pressured air by a pressurized air connection line 58 (FIG. 2) and channels formed in valve 10, in order to press piston 56 and valve body 52 into the closed position.

A pressurized air channel 58 formed in upper body 4 of base body 2 leads to a cylinder chamber 60 located below piston 56, so that pressurized gas may be introduced into this chamber at a pressure such that piston 56 and valve body 52 are moved upward and into the open position, so that the flow of fluid is released. Pressurized air channel 58 is attachable to a source of pressurized gas by a connection 62. An electrically controllable valve, not shown, introduces pressurized air selectively into pressurized air channel 58 to open valve 10. When a large application width is to be achieved, a large number of application valves 10 may be connected in series, and correspondingly a large number of pressurized air channels 58 may be formed in base body 2. Pressurized air is then introduced into the plurality of pressurized air channels 58 by a transverse distribution channel 64. Line 58 is connected to a source of pressurized air by a connection 66 (FIG. 2). Inserting valves 10 into bore 24 and forming pressurized air channels 58 in base body 2 (of body 4) results in a compact design without troublesome external connecting lines.

The geometry and the variability of the geometric conditions of outlet channel 32 of nozzle 8 are explained in greater detail below. In the exemplary embodiment, nozzle 8 is designed as a slot nozzle, and outlet channel 32 is slot-shaped and is designed as a gap that tapers down continuously to outlet opening 34. The flow cross section of outlet channel 34 thus becomes smaller in the direction of flow of the fluid. In a manner not shown, alternatively and according to an alternative exemplary embodiment, outlet channel 32 could be design as a cylindrical, conically tapered bore whose flow cross section also becomes continuously smaller until outlet opening 34. In the exemplary embodiment shown, outlet channel 32 is bounded (as FIG. 1 shows) by a section of upper body 4—located to the right in FIG. 1—and an opposing section—to the right section in FIG. 1—of lower body 6 of base body 2. The opposing surfaces 68, 70 (see FIGS. 3 and 4) of opposing bodies 4, 6 are ground and polished in the area of outlet channel 32. Outlet channel 32 is designed as a continuously tapering gap.

Application device 2 according to the invention includes an adjusting device 72 for continuously varying the flow cross section of outlet channel 32 of nozzle arrangement 8. In the exemplary embodiment adjusting device 72 (FIG. 1) provides for infinitely variable adjustment of at least one section of body 4 relative to the opposing body 6 in the area of outlet channel 32. Adjusting device 72 has an adjusting bolt 74 which has outside threading and has one end screwed into a threaded bore 76 of body 4. Bolt 74, which protrudes in front of body 4, is inserted through a through bore 80 in a projection 78 of body 4. A nut 82 secures bolt 74 axially relative to body 4. With the help of two additional nuts 84, 86 which are screwed onto bolt 74, it is possible to apply an adjusting force that acts essentially in the longitudinal direction of bolt 74 to projection 78 of body 4, so that, as indicated by arrow 88 in FIG. 1, a torque is applied to projection 78 in such a way that by tightening nuts 84 or 86 either a certain spreading of section 90 of body 4 results and the width of the slit-formed outlet channel 32 increases and thus the flow cross section increases, and also the width—measured in the direction of the relative motion direction 36—outlet opening 34 increases or decreases. This makes continuously variable adjustment or variation of the width and flow cross section of outlet channel 32 possible.

This adjustment is made possible by an elastic ductility of body 4, or more precisely, of section 90 of body 4 in the area of outlet channel 32 due to the application of force by means of adjusting device 72. Due to a recess 34, essentially U-shaped in cross section, section 90 has a section 96 of relatively small thickness, in which especially great elastic deformability is possible.

As FIG. 2 makes clear, in the illustrated exemplary embodiment a multiplicity of seven adjacent adjusting devices 72 are provided with seven bolts 74 which act on projection 78 of body 4, and which make it possible to uniformly and continuously vary the geometry, in particular the width and the flow cross section of outlet channel 32 and of outlet opening 34 of nozzle 8 over the entire width of nozzle 8, by appropriate adjustment of nuts 84, 86. It is especially preferable to set a width of the outlet opening of outlet channel 32 between 0.05 mm and 0.5 mm by operating the adjusting device 72. The width is measured between the apexes 69 and 71 of bodies 4 and 6 shown in FIG. 3.

In operation liquid adhesive, for example, is directed into feed channel 12 by gear pumps. It is initially present under pressure at closed valve 10. By introducing pressurized gas into pressurized air channel or channels 58, valve 10 is brought to the open position and valve body 52 moves away from valve seat 54, so that fluid flows through feed channel 12 and flows through outlet channel 32, which has first been adjusted in the manner described above. The fluid emerges from outlet opening 34 in the form of a thin film or sheet. In the area of outlet channel 32, fluid pressures in the range between 30 and 100 bar are produced. The fluid emerges at high speed from outlet opening 34 and is deposited on the surface of the substrate (not shown), which is moving relative to device 1 in the direction of arrow 36. The substrate is positioned, for example, at a distance of 2 to 10 millimeters from outlet opening 34. The relative speed and the mass flows of the fluid and the width adjustment of the flow cross section and the outlet opening 34 are matched to each other so that a uniform deposit of the generated sheet or film on the surface of the substrate is achieved. It is especially preferable for the fluid to be a constantly sticky hot melt pressure sensitive adhesive or an acrylic-based or rubber-based adhesive or a UV-curing adhesive.

If valve 10 is brought to the closed position, the flow of fluid in feed channel 12 is interrupted, so that the flow of the fluid in outlet channel 32 and through outlet opening 34 is also interrupted. The width of outlet opening 34 may be varied by actuating device 72 as previously described.

With the help of fasteners 98 it is possible to place device 1 in a stationary location in any desired orientation relative to the path of motion 36 of the substrate.

1-13. Canceled.

14. An apparatus for dispensing fluid onto a substrate, comprising:
a base member having a feed channel,
a slot nozzle having first and second spaced apart members,
a slot-shaped outlet channel in fluid communication with said feed channel and defined between said first and second spaced apart members,
a slot-shaped outlet opening in fluid communication with said slot-shaped outlet channel and having a width defined between said first and second spaced apart members,
a valve coupled with said base member and operative to selectively interrupt and release the flow of fluid through said slot-shaped outlet opening, and
an adjustment device operative to infinitely adjust the position of said first member relative to the position of said second member to change the width of said slot-shaped outlet opening.

15. The apparatus of claim 14, wherein said first member is elastically deformable by said adjustment device to change the width of said slot-shaped outlet opening.

16. The apparatus of claim 15, wherein said first member further comprises an abutment and said adjustment device further comprises an adjuster bolt engaged with said abutment.

17. The apparatus of claim 15, wherein the width of said slot-shaped outlet opening is adjustable in a range between about 0.05 mm and 0.5 mm.

18. The apparatus of claim 14, wherein said slot-shaped outlet channel tapers continuously in a direction toward said slot-shaped outlet opening.

19. A method for dispensing fluid onto a substrate from a dispensing device comprising a base member, a feed channel within the base member, a slot-shaped outlet channel communicating with the feed channel, and a slot-shaped outlet opening communicating with the slot-shaped outlet channel, the slot-shaped outlet channel tapering in a direction toward the slot-shaped outlet opening, comprising:
directing the fluid through the feed channel and into the slot-shaped outlet channel,
directing the fluid through the slot-shaped outlet channel while continuously increasing the pressure of the fluid in the slot-shaped outlet channel, and
dispensing the fluid through the slot-shaped outlet opening at a pressure between approximately 30 bar and 100 bar.

20. The method of claim 19, further comprising:
dispensing the fluid through the slot-shaped outlet opening at a pressure between approximately 40 bar and 70 bar.

21. The method of claim 19, wherein the slot-shaped outlet opening is contained in a nozzle, and further comprising:
dispensing the fluid through the slot-shaped outlet opening as a film without contacting the substrate with the nozzle.

22. The method of claim 19, wherein the fluid further comprises a pressure sensitive hot melt adhesive.

23. The method of claim 19, wherein the fluid further comprises one of an acrylic-based pressure sensitive adhesive, a rubber-based pressure sensitive adhesive, or an ultraviolet light curable pressure sensitive adhesive.
